(19) United States
(12) Patent Application Publication
(10) Pub. No.: US 2004/0155899 A1
(43) Pub. Date: Aug. 12, 2004

(54) Method and system for presenting an arrangement of management devices operable in a managed network

(76) Inventor: Jeffrey Richard Conrad, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/361,863

(22) Filed: Feb. 11, 2003

(51) Int. Cl. G09G 5/00

(52) U.S. Cl. 345/736; 345/738

(57) ABSTRACT

A method and system are described for presenting an arrangement of management devices operable in a managed network. According to exemplary embodiments, a number of management devices arranged in the managed network are identified. Identities of the management devices are presented in a graphical user interface (GUI). Visual cues are added to the GUI to identify a communication status between a first of the management devices and each of the remaining management devices arranged in the managed network. A software link can be provided between each presented identity and the respective management device to provide automated access to management information maintained at the respective management device. A graphical representation and an operational status of a portion of the managed network can be presented based on the management information maintained at the respective management device in the GUI via the software link.

### BACKGROUND

In many fields of process management, operators face technical challenges as they work to maintain an optimal performance level of the process being managed. For example, in the area of network management, operators determine the current state of a network—what devices are present, how they are configured, how they are behaving, their performance levels, what is currently going wrong. Operators identify trends and determine how to optimize the network by changing configurations, replacing network devices, and so forth. Operators also learn how to predict what might go wrong, determine how to prevent it from happening, and learn to avoid future problems. The challenges can be difficult when tasked with managing large enterprise networks.

Network management products, such as Hewlett Packard's Network Node Manager (HP's NNM), aid operators in managing large enterprise network. These products can poll for network information to determine network topologies and screen for problems (or events) through event correlation. They can also assist operators in identifying trends by collecting historical information for use with statistical analysis programs. The products also assist operators in proactively addressing network events monitoring thresholds of critical network devices.

Often operators employ a centralized management model in which one management device (commonly referred to as a management station or MS) performs all monitoring and data collection functions for a whole management domain. There is little or no remote network management hardware or personnel. Such a scheme is illustrated in FIG. 1A.

The centralized management model can present problems when applied to large enterprise networks. First, the traffic overhead that network management can impose on congested or expensive network links, can make it impractical to monitor tens of thousands of nodes from a single workstation. Second, using a single centralized management device can present a risk of losing all network management in the event of an unexpected shutdown of the management device. Third, response times can be slow for remotely located managed devices, resulting in more time waiting for data at the management device than time acting on it. In addition, centralized management can make it difficult to later change the topology of the managed network.

These concerns can be addressed by applying the concepts of scalability and distributed monitoring and management in the network management model. FIG. 1B illustrates an exemplary distributed model for network monitoring and management. In a distributed model, one or more remote management devices designated as collection stations (CS) are tasked with monitoring a portion of the network and informing all interested management devices of any changes in the status or topology of the network portion being monitored. While distributed management can lead to more efficient gathering of fault, performance, and configuration information from a large enterprise network, it can present challenges in presenting this information to an operator in an efficient and meaningful manner so as to enable a proactive management of the network.

Network management products use graphical network topology maps to present management information to operators. Network topology maps can be organized into a hierarchical structure of submaps or views. A view can be presented in a high-level submap that represents the entire enterprise network, perhaps spanning the world, or can be presented in a more detailed submap representing any portion of the network. HP's NNM program product has a default map that includes four hierarchical submaps: an Internet-level submap (e.g., showing IP networks), a Network-level submap (e.g., showing bus, star, or ring segments), a Segment-level submap (e.g., showing hosts and routers), and a Node-level submap (e.g., showing network interface cards or NICs). A single submap can be presented to an operator at any given time.

When monitoring the performance of devices or determining the root cause of a network event associated with a particular portion of a network, it can be helpful for an operator to know the identities of management device(s) gathering information in that portion of the network. Such information can be particularly helpful when network-level and segment-level physical topologies cross the management boundaries of several management devices. Yet, the topology maps generated by network management program products can be focused on the physical topology of network being managed and not the network management infrastructure itself.

### SUMMARY

A method and system are described for presenting an arrangement of management devices operable in a managed network. According to exemplary embodiments, a number of management devices arranged in the managed network are identified. Identities of the management devices are presented in a graphical user interface (GUI). Visual cues are added to the GUI to identify a communication status between a first of the management devices and each of the remaining management devices arranged in the managed network.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIGS. 1A & 1B show centralized and distributed arrangements for managing a network, respectively;

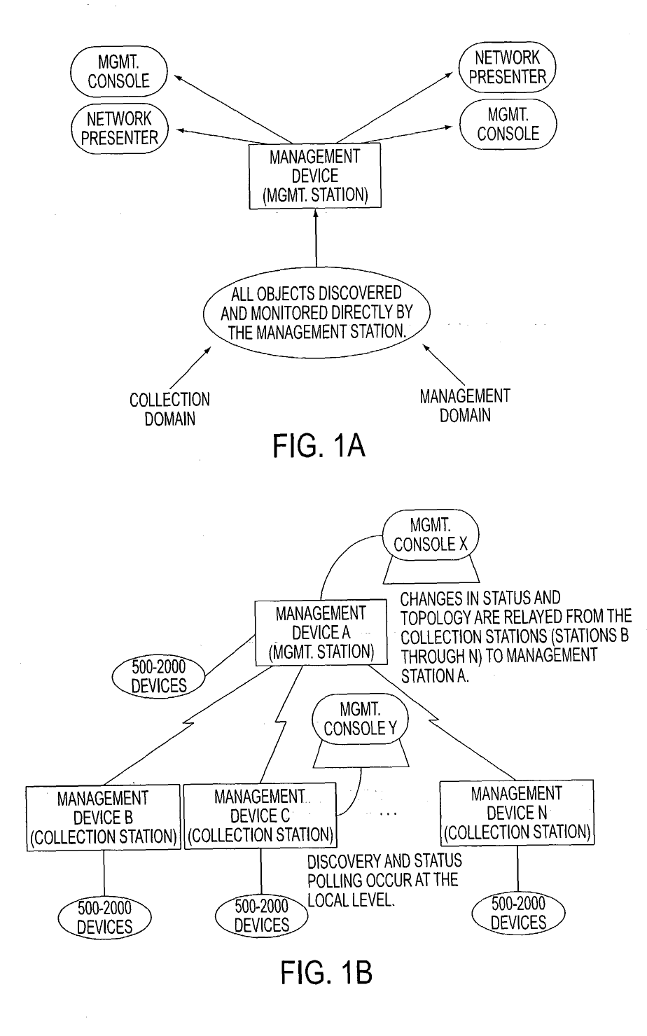

FIG. 2 is a flowchart for presenting an arrangement of management devices operable in a managed network according to an exemplary embodiment;

FIG. 3 shows an arrangement for presenting an arrangement of management devices operable in a managed network according to an exemplary embodiment; and

FIG. 4 depicts a topology map of a portion of a distributed managed network managed by a particular management device according to an exemplary embodiment.

### DETAILED DESCRIPTION OF THE PREFERRED EMBODIMENTS

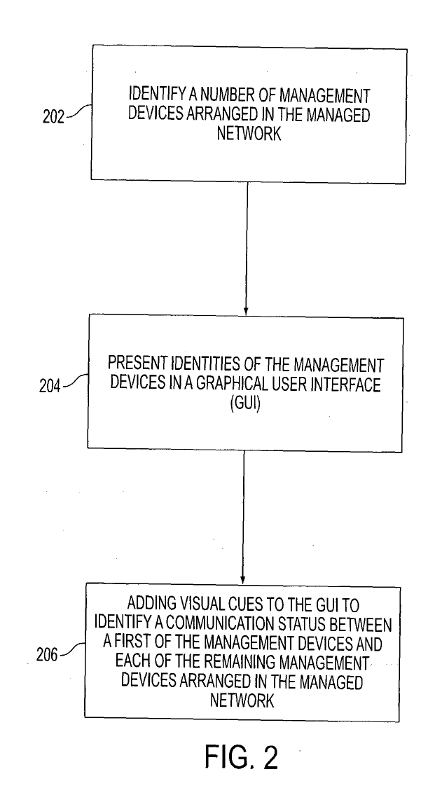

FIG. 2 is a flowchart for presenting an arrangement of management devices operable in a managed network according to an exemplary embodiment. In step 202, a number of management devices arranged in the managed network are identified. NNM and other network management products can initially perform a discovery process that automatically discovers each device on a network. The discovery process can uncover information related to each network device. For example, by examining the device's Management Information Base (MIB), and the connective relationship between the device and other devices discovered on the network. Among the discovered devices are the management devices themselves.

Information uncovered during the discovery process can be stored in one or more management data models or data stores. This information can include an identity (e.g., a Physical Address, hostname and/or IP address) of a device, a relative location of a device in the network (e.g., within a network, or a segment portion, etc.), and identifiers of management devices configured to manage the device (e.g., an interface ID, node ID, network ID or segment ID). In addition, a management data store can include information describing whether a particular device is configured to function as a management device (e.g., as an MS or a CS).

For example, NNM's discovery process is capable of determining whether a discovered device itself has NNM installed, and of storing information related to the management capabilities of such discovered devices in its management data store. The stored information can be mined to identify those devices, arranged throughout a distributed managed network, that are configured to operate as management devices. In addition, the management data stores can be mined to identify devices included in the management and/or collection domains of a particular management device (i.e., to determine the devices managed by the particular management device).

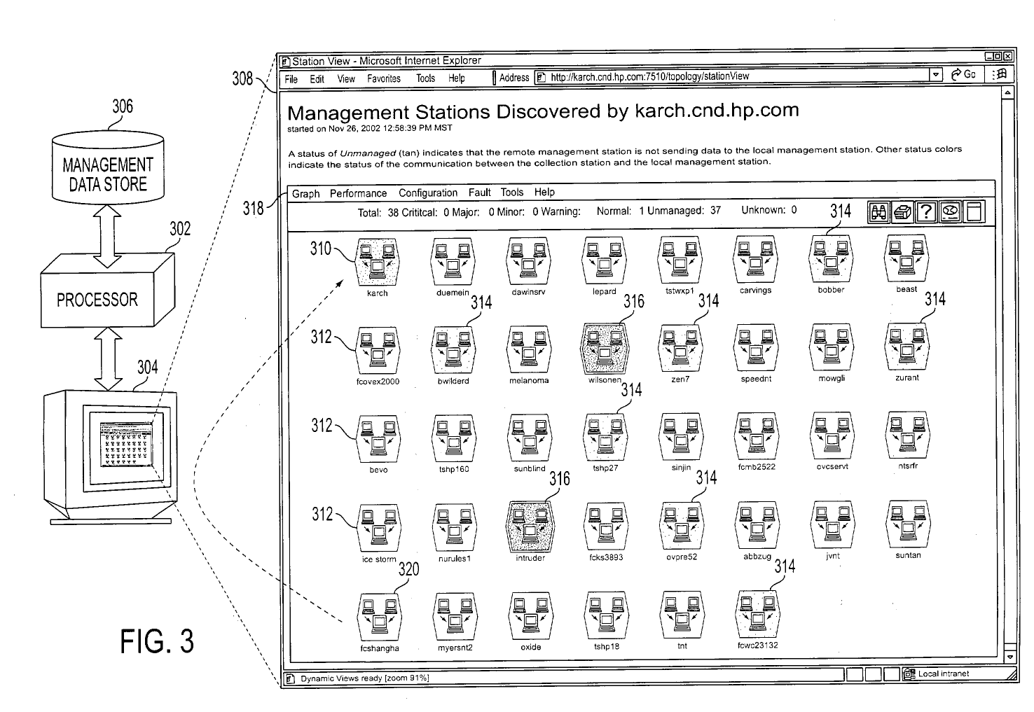

In step 204, identities of the management devices are presented in a graphical user interface (GUI). An exemplary GUI is depicted in FIG. 3. The GUI 308 shown includes the identities of thirty-eight management devices identified in step 202. The identities can be presented on one or more pages of the GUI. In the example shown, the identities are presented on a single page of the GUI 308, but other embodiments can include arrangements in which the identities are presented on multiple pages of the GUI.

The GUI 308 can be displayed on a display 304 operatively coupled to a management device. For example, the GUI 308 can be displayed on a management console that can be used to off-load display processing from the management device to a display station. Multiple management consoles can enable a number of operators to simultaneously monitor and manage large network environments with higher performance and efficiency. Alternatively, the GUI 308 can be a web-browser interface as shown in FIG. 3. A web-browser interface can enable operators to monitor and manage a network from any browser-capable device in the network, even if the device is not a management console.

In step 206, visual cues are added to the GUI 308 to identify a communication status between a first 310 of the management devices and each of the remaining management devices 312/314/316 arranged in the managed network. “Visual cues”, as used herein, can include any visual attribute of the GUI 308 that can be used to signify a communication status between the first management device 310 and the remaining management devices 312/314/316 arranged throughout the network.

An exemplary list of visual attributes, which can be unique (for example, a unique combination) within the GUI for each management device, includes: relative positioning (i.e., between the identities of the first management device 310 and the remaining management devices 312/314/316, e.g. indenting, tabbing, hierarchical listing), color (foreground and\or background), orientation, shading, graphics (e.g., 3D, dashed or solid lines), and identifier text attributes (e.g., underlining, italics, bold, case, alphabetized). Other visual attributes can include additional text (e.g., labels, hostnames, IP addresses) and varying symbol types (e.g., unique symbols to distinguish an MS from a CS management device). Visual cues can also be provided in a mouse-over popup window. It will be understood that these exemplary lists of visual cues provided are not exhaustive.

According to exemplary embodiments, first visual cues can be added to identify the first management device 310 presented in the GUI 308. The first management device 310 can be the device to which a management console used to display the GUI 308 is directly attached, or can be selected by an operator as a device of interest via, for example, a web-browser interface. The first management device 310 can be tasked with managing a portion of the network of interest to an operator, for example, in determining the root cause of a network event generated by device managed in the portion.

In the example shown, unique text, positioning, and shading/coloring are combined to identify the first management device 310 in the GUI 308. First, the hostname “karch” is positioned near the symbol. Second, the symbol for the device 310 is positioned in uppermost left corner of the GUI 308 relative to the remaining symbols presented in the GUI 308. Third, the symbol for the device 310 is presented using a coloring/shading (e.g., blue) that is unique among all other symbols presented in the GUI.

Second visual cues can be added to the presented identities of management devices 312 not configured to gather management information on behalf of the first management device 310. Such devices are configured to manage devices in the network, but not in the same network portion (e.g., Internet-level) as the first management device 310. In the example shown, identities of these devices 312 are presented in GUI 308 with no coloring or shading, and include their respective hostnames positioned near the symbols. While the devices 312 may not be configured to gather information on behalf of the first management device 310, peer-level communication between the first management device 310 and these devices 312 can still occur. Accordingly, a unique coloring/shading or other visual cue (not shown) can be added to those devices 312 presented in the GUI 308 having a failed peer-level communication status with the first management device 310.

Third visual cues can be added to the presented identities of management devices 314 configured to gather management information on behalf of the first management device 310 and having a functioning communication status with the first management device 310. In the example shown, identities of these management devices 314 are presented in the GUI 308 using a coloring/shading (e.g., green) that is unique among the group of devices 314. The management devices 314 can be collection stations configured to poll and gather management information from devices in their respective collection domains, and to send this information to the first management device 310 which can be configured to operate as a management station. With such an arrangement, the first management device 310 and the devices 314 (and the devices 316 described below) can be said to form a management domain of the network.

Fourth visual cues can be added to the presented identities of management devices 316 configured to gather management information on behalf of the first management device 310 and having a failed communication status with the first management device 310. In the example shown, identities of these management devices 316 are presented in the GUI 308 using a coloring/shading (e.g., red) that is unique among the group of devices 316. Again, the management devices 316 can be collection stations configured to poll and gather management information from devices in their respective collection domains, and to send this information to the first management device 310 which can be configured to operate as a management station. Additional coloring/shading can be added to identities that have an unknown or undetermined status.

The identities of the management devices 314/316 configured to gather information on behalf of the first management device 310 can be presented in the GUI 308 using a random or pseudo-random (e.g., discovery order) positioning. Alternatively, the management devices 314/316 can be “clustered” around the first management device 310 to identify a management/collection relationship among the devices. The management devices 314/316 can also be presented in hierarchical tree structure, with the first management device 310 at the top of the tree, to identify the management/collection relationship among the devices.

According to exemplary embodiments, a software link can be provided between each presented identity and the respective management device to provide automated access to management information maintained at the respective management device. The first software link can be associated with any portion of the presented identity. Where the GUI 308 is a web-browser interface, the link can be a “hypertext” link associated with the hostname of the device, e.g., the hostname “karch” of the first management device 310. As will be understood by those skilled in art, when a user positions an input selection device (e.g., a mouse) over such a hyperlink and makes a selection (e.g., by “double-clicking” a mouse button), management information maintained at the corresponding management device can be presented in the GUI 308.

The software link can also be associated with the symbol of a presented identity, or associated with a control included on GUI 308. For example, an operator can select an identity presented in the GUI 308, e.g., by “single-clicking” on the identity using a mouse, and then activate a control, such as the control 318 labeled “Graph”, to display the communication status between the selected device and the remaining management devices presented in the GUI 308.

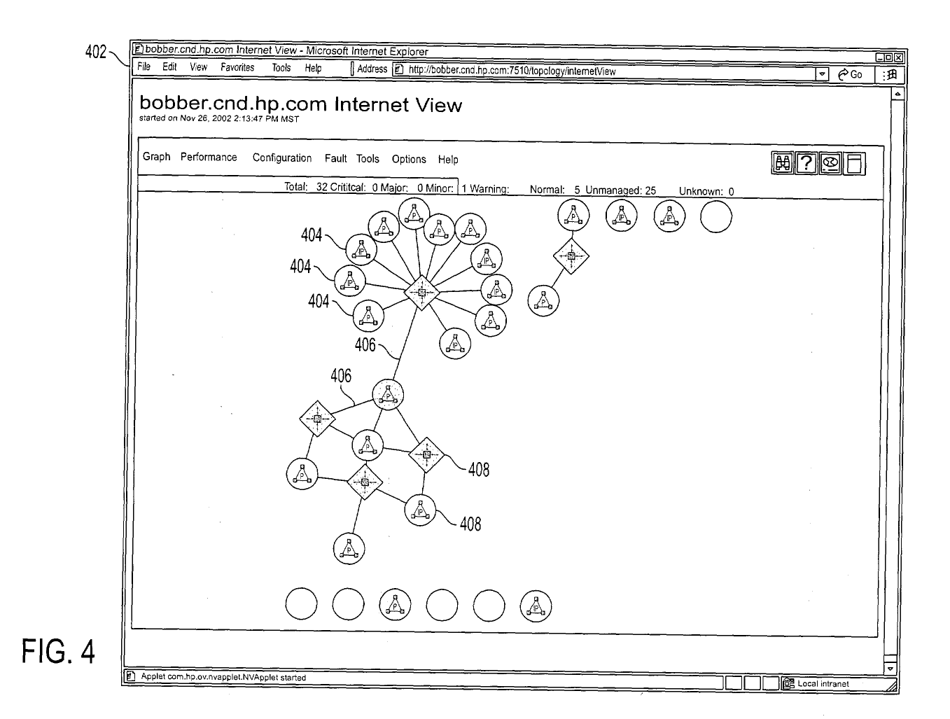

A graphical representation and an operational status of a portion of the managed network can be automatically accessed via the software link and then presented in the GUI 308 based on the management information maintained at the respective management device. For example, when an operator “double-clicks” a mouse button (e.g., the left button) over the identity of the management device 314 in the first row of the GUI 308 having the hostname “bobber”, an Internet view 402 of the portion of the network with the management and/or collection domain of the selected device can be presented in the GUI 308. The Internet view 402 as shown in FIG. 4 can include identities of the devices 404 in the managed portions, and visual cues, such as the lines 406 shown, to identify a physical connectivity among the devices. Additional visual cues, such as the coloring/shading 408 shown, can be added to indicate the operational status of the devices included in the managed network portion. Management information displayed in the Internet view 402 can be mined from a data store residing on the selected remote host, e.g., “bobber” in this example. Different Internet views 402 can be generated and displayed to an operator for any selected identity presented in the GUI 308.

Identities of the management devices can be presented on a single page of the GUI 308 (as illustrated in FIG. 3) or can be presented on multiple pages of the GUI 308. For example, the identity of the first management device 310 can be presented on a first page of the GUI 308, together with identities of management devices 312 not configured to gather management information on behalf of the first management device. An identity of a second management device 314/316 configured to gather management information on behalf of the first management device 310 on a second page of the GUI 308 (not shown). A software link can then be provided between the identity of the first management device 310, presented on the first page of the GUI 308, and the second page to provide automated access to the second page via the link. The software link can again be associated with the symbol and/or hostname of the presented identity and can be activated by “double-clicking” a mouse button (e.g., the right button) over the symbol and/or hostname. The software link can also be associated with a control included on the GUI 308. Management information presented on the second page of the GUI 308 can be mined from a data store residing on the first management device 310. Additional nested pages (not shown) can be included in the GUI 308 to correspond to additional levels in the management/collection station hierarchy.

While viewing a station view of the managed network with respect to the first management device 310, the visual cues presented in the GUI 308 can be modified to identify a communication status between a second 320 of the management devices and each of the remaining management devices arranged in the managed network. As described above, an operator can select an identity presented in the GUI 308, e.g., by “single-clicking” on the identity using a mouse, and then activate a control, such as the control 318 labeled “Graph”, to display the communication status between the selected device 320 and the remaining management devices presented in the GUI 308.

The presentation of identities in the GUI 308 can then be modified such that the identity of the selected device 320 is repositioned in the GUI 308 (e.g., to the uppermost left corner of the presentation as indicated by the dashed arrow), and the coloring/shading and/or positioning of the remaining devices updated to indicate their communication status with the second management device 320.

Various aspects will now be described in connection with exemplary embodiments. To facilitate an understanding of these embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both. Moreover, the exemplary embodiments can be considered part of any form of computer readable storage medium having stored therein an appropriate set of computer instructions that would cause a processor to carry out the techniques described herein.

Thus, the various aspects can be embodied in many different forms, and all such forms are contemplated to be within the scope of what is described. For each of the various aspects, any such form of embodiment can be referred to herein as “logic configured to” perform a described action, or alternatively as “logic that” performs a described action or as “logic capable of” performing the action.

A system for presenting an arrangement of management devices operable in a managed network according to an exemplary embodiment is shown in FIG. 3. The system includes a processor 302 and a display 304. The processor 302 includes logic configured to identify a number of management devices arranged in the managed network. The processor 302 can mine information stored in a management data store 306 to identify the management devices arranged throughout a distributed managed network.

The processor 302 further includes logic configured to present identities of the management devices in a graphical user interface (GUI) and logic configured to add visual cues to the GUI to identify a communication status between a first of the management devices and each of the remaining management devices arranged in the managed network. The GUI, including the presented identities and visual cues, can be displayed on the display 304. The display 304 can be the display of a management console directly attached to first management device 310, or can be a display attached to any device in the network including a web-browser interface.

The term “visual cues” has a meaning consistent with that described in conjunction with the exemplary method illustrated in FIG. 2. In addition, the processor can include logic capable of performing the various tasks described above in conjunction with the exemplary method illustrated in FIG. 2.

The steps of a computer program as illustrated in FIG. 2 for presenting an arrangement of management devices operable in a managed network can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used herein, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

The computer program performs the steps of identifying a number of management devices arranged in the managed network, and presenting identities of the management devices in a graphical user interface (GUI). The following exemplary pseudo-code illustrates a process for performing these functions:

```
requestSnmpManagementStationVars(node) {
  // Try sending a Simple Network Management Protocol (SNMP)
  // message to the node. If the SNMP variables supported by
  // network management software, e.g., NNM is returned,
  // a management node has been discovered.
  // Gather variables such as status, licensing, mgmt. domain,
  // number of nodes, etc., and return them. Otherwise, return
  // null
}
// First, perform discovery to identify nodes in network.
// Periodically keep the list of management device current by:
foreach node in discoveredNodeList {
  result = requestSnmpManagementStationVars(node);
  if (result == null) continue; // node is not a mgt. device
  // Node is a management device
  addToMgmtStationList(node);
  info = getMgmtStationStatusAndParameters(node);
  storeMgmtStationStatusAndParameters(info);
}
```

The identified management devices can be presented in the GUI and visual cues can be added to identify a communication status between a first of the management devices and each of the remaining management devices arranged in the managed network.

The computer program can also perform the steps of providing a software link between each presented identity and the respective management device to provide automated access to management information maintained at the respective management device, and presenting a graphical representation and an operational status of a portion of the managed network based on the management information maintained at the respective management device in the GUI via the software link. The following exemplary pseudo-code illustrates a process for performing these functions in conjunction with an embodiment using a web-browser interface:

```
// When a StationView is requested, e.g., through a web-browser
// interface directed at this machine, perform the steps:
foreach node in mgmtStationList {
  // this node is a mgmt station or collection station,
  // it performs a mgmtStation function
  url = “http://” + node + “/topology/internetView”;
  displayInStationViewWithURL(node, url);
}
```

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for presenting an arrangement of management devices operable in a managed network, the method comprising:
identifying a number of management devices arranged in the managed network;
presenting identities of the management devices in a graphical user interface (GUI); and
adding visual cues to the GUI to identify a communication status between a first of the management devices and each of the remaining management devices arranged in the managed network.

2. The method of claim 1, comprising:
providing a software link between each presented identity and the respective management device to provide automated access to management information maintained at the respective management device.

3. The method of claim 2, comprising:
presenting a graphical representation and an operational status of a portion of the managed network based on the management information maintained at the respective management device in the GUI via the software link.

4. The method of claim 1, wherein identities of the management devices are presented on a single page of the GUI.

5. The method of claim 1, comprising:
presenting the identity of the first management device on a first page of the GUI, together with identities of management devices not configured to gather management information on behalf of the first management device;
presenting an identity of a second management device configured to gather management information on behalf of the first management device on a second page of the GUI; and
providing a software link between the identity of the first management device and the second page to provide automated access to the second page via the link.

6. The method of claim 5, wherein the first management device is a management station and the second management device is a collection station.

7. The method of claim 1, wherein the adding visual cues comprises:
adding first visual cues to identify the first management device presented in the GUI;
adding second visual cues to presented identities of management devices not configured to gather management information on behalf of the first management device;
adding third visual cues to presented identities of management devices configured to gather management information on behalf of the first management device and having a functioning communication status with the first management device; and
adding fourth visual cues to presented identities of management devices configured to gather management information on behalf of the first management device and having a failed communication status with the first management device.

8. The method of claim 1, comprising:
modifying the visual cues presented in the GUI to identify a communication status between a second of the management devices and each of the remaining management devices arranged in the managed network.

9. A system for presenting an arrangement of management devices operable in a managed network, the system comprising:
a processor, including:
logic configured to identify a number of management devices arranged in the managed network;
logic configured to present identities of the management devices in a graphical user interface (GUI); and
logic configured to add visual cues to the GUI to identify a communication status between a first of the management devices and each of the remaining management devices arranged in the managed network; and
a display for displaying the GUI including the presented identities and visual cues.

10. The system of claim 9, wherein the processor comprises:
logic configured to provide a software link between each presented identity and the respective management device to provide automated access to management information maintained at the respective management device.

11. The system of claim 10, wherein the processor comprises:
logic configured to present a graphical representation and an operational status of a portion of the managed network based on the management information maintained at the respective management device in the GUI via the software link.

12. The system of claim 9, wherein identities of the management devices are presented on a single page of the GUI.

13. The system of claim 9, wherein the processor comprises:
logic configured to present the identity of the first management device on a first page of the GUI, together with identities of management devices not configured to gather management information on behalf of the first management device;
logic configured to present an identity of a second management device configured to gather management information on behalf of the first management device on a second page of the GUI; and
logic configured to provide a software link between the identity of the first management device and the second page to provide automated access to the second page via the link.

14. The system of claim 13, wherein the first management device is a management station and the second management device is a collection station.

15. The system of claim 9, wherein the logic configured to add visual cues comprises:
logic configured to add first visual cues to identify the first management device presented in the GUI;
logic configured to add second visual cues to presented identities of management devices not configured to gather management information on behalf of the first management device;
logic configured to add third visual cues to presented identities of management devices configured to gather management information on behalf of the first management device and having a functioning communication status with the first management device; and
logic configured to add fourth visual cues to presented identities of management devices configured to gather management information on behalf of the first management device and having a failed communication status with the first management device.

16. The system of claim 9, wherein the GUI comprises:
a control configured to modify the visual cues presented in the GUI to identify a communication status between a second of the management devices and each of the remaining management devices arranged in the managed network.

17. A computer readable medium containing a computer program for presenting an arrangement of management devices operable in a managed network, wherein the computer program performs the steps of:
identifying a number of management devices arranged in the managed network;
presenting identities of the management devices in a graphical user interface (GUI); and
adding visual cues to the GUI to identify a communication status between a first of the management devices and each of the remaining management devices arranged in the managed network.

18. The computer readable medium of claim 17, wherein the computer program performs the step of:
providing a software link between each presented identity and the respective management device to provide automated access to management information maintained at the respective management device.

19. The computer readable medium of claim 18, wherein the computer program performs the step of:
presenting a graphical representation and an operational status of a portion of the managed network based on the management information maintained at the respective management device in the GUI via the software link.

20. The computer readable medium of claim 17, wherein the computer program performs the steps of:
presenting the identity of the first management device on a first page of the GUI, together with identities of management devices not configured to gather management information on behalf of the first management device;
presenting an identity of a second management device configured to gather management information on behalf of the first management device on a second page of the GUI; and
providing a software link between the identity of the first management device and the second page to provide automated access to the second page via the link.
